(19) United States
(12) Patent Application Publication
(10) Pub. No.: US 2024/0235338 A1
(43) Pub. Date: Jul. 11, 2024

(54) CLAMP DEVICE AND METHOD OF MANUFACTURING STATOR

(71) Applicant: TOYOTA JIDOSHA KABUSHIKI KAISHA, Toyota-shi (JP)

(72) Inventor: Kento FURUTA, Toyota-shi (JP)

(73) Assignee: TOYOTA JIDOSHA KABUSHIKI KAISHA, Toyota-shi (JP)

(21) Appl. No.: 18/496,073

(22) Filed: Oct. 27, 2023

(30) Foreign Application Priority Data
Jan. 11, 2023 (JP) 2023-002411

(51) Int. Cl. H02K 15/00; B21F 3/02

(52) U.S. Cl. CPC H02K 15/0081; B21F 3/02

(57) ABSTRACT

The first shaft and the second shaft restrict the positions of the first end portion and the second end portion in the circumferential direction of the stator core with the first end portion and the second end portion interposed therebetween. Each of the first shaft and the second shaft has a groove. The groove is defined by a first side wall, a second side wall, and an end wall connecting the first side wall and the second side wall. A first side wall of the first shaft presses the first curved portion radially outward of the stator core. The second side wall of the second shaft presses the second curved portion radially inward of the stator core. Thereby, the first segment coil and the second segment coil are clamped in a state where the first end portion and the second end portion are brought into contact with each other.

### CROSS-REFERENCE TO RELATED APPLICATION

This application claims priority to Japanese Patent Application No. 2023-002411 filed on Jan. 11, 2023, incorporated herein by reference in its entirety.

### BACKGROUND

### 1. Technical Field

The present disclosure relates to a clamp device and a method of manufacturing a stator.

### 2. Description of Related Art

Japanese Unexamined Patent Application Publication No. 2018-082543 (JP 2018-082543 A) discloses a method of manufacturing a stator provided in a rotary electric machine. First, a clamp device clamps a plurality of segment coils disposed in a stator core. The clamped segment coils are then welded together. In this way, the stator is manufactured. The plurality of segment coils is covered by an insulating coating film. The end portions in which the coating film is stripped are welded together. The first segment coil of the segment coils has a first curved portion and a first end portion. The first curved portion protrudes from the stator core and extends clockwise as viewed from the axial direction of the stator core. The first end portion is continuous with the first curved portion and extends in the axial direction of the stator core. The first end portion has a first stripped portion in which the coating film is stripped off. The second segment coil of the segment coils has a second curved portion and a second end portion. The second curved portion protrudes from the stator core and extends counterclockwise as viewed from the axial direction of the stator core. The second end portion is continuous with the second curved portion and extends in the axial direction of the stator core. The second end portion has a second stripped portion in which the coating film is stripped off. In the manufacturing method of JP 2018-082543 A, the first stripped portion and the second stripped portion are clamped by an electrode. The clamped first stripped portion and the second stripped portion are electrically coupled through a tungsten inert gas (TIG) welding.

### SUMMARY

In JP 2018-082543 A, the first stripped portion and the second stripped portion are electrically coupled through TIG welding. In order to perform TIG welding, the first stripped portion and the second stripped portion need to be long enough to be clamped by the electrode. Accordingly, the size of the stator is increased, which is not preferable.

A method of coupling the first stripped portion and the second stripped portion through laser welding is conceivable. In this case, it is not necessary to clamp the first stripped portion and the second stripped portion by the electrode. Therefore, the first stripped portion and the second stripped portion can be shortened as compared with TIG welding is performed.

However, when these stripped portions are short, heat generated due to laser welding is easily transmitted to coating films near the stripped portions. Therefore, the coating films may be damaged because the temperature of the coating films become high.

In the above-described method of manufacturing a stator, heat generated due to welding may damage the coating films of the segment coils.

Means for solving the above problems and their effects will be described below.

According to an aspect of the present disclosure, there is provided a clamp device configured to clamp two segment coils disposed in a stator core. The two segment coils are each covered with an insulating coating film. The two segment coils include two curved portions that project from the stator core and respectively extend clockwise and counterclockwise as viewed from an axial direction of the stator core, and two end portions that are respectively continuous with the two curved portions and extend away from the stator core in the axial direction of the stator core. The two end portions include a first end portion of a first segment coil of the two segment coils and a second end portion of a second segment coil of the two segment coils. The first end portion is, of the two end portions, an end portion located radially inward of the stator core, and the second end portion is, of the two end portions, an end portion located radially outward of the stator core. The two curved portions include a first curved portion and a second curved portion. The first curved portion is a curved portion of the two curved portions and continuous with the first end portion, and the second curved portion is a curved portion of the two curved portions and continuous with the second end portion. The clamp device is used to couple a first stripped portion and a second stripped portion through laser welding with the first end portion and the second end portion facing each other. The first stripped portion is a portion from which the coating film is stripped off at the first end portion, and the second stripped portion is a portion from which the coating film is stripped off at the second end portion.

The clamp device includes: a first shaft disposed so as to extend in a radial direction of the stator core; and a second shaft adjacent to the first shaft in a circumferential direction of the stator core and disposed to extend in the radial direction of the stator core.

The first shaft and the second shaft are the same in shape.

The first shaft and the second shaft are each provided with a groove extending in the circumferential direction of the stator core on a stator core side surface.

The groove is defined by a first side wall, a second side wall, and an end wall connecting the first side wall and the second side wall, and the first side wall is located radially inward of the stator core than the second side wall.

The first side wall and the second side wall are closer to each other as the first side wall and the second side wall are closer to the end wall.

The first shaft and the second shaft are spaced apart from each other in the circumferential direction of the stator core so as to restrict positions of the first end portion and the second end portion in the circumferential direction of the stator core with the first end portion and the second end portion sandwiched between the first shaft and the second shaft. In a state in which the first end portion and the second end portion are sandwiched between the first shaft and the second shaft, by moving the clamp device to be close to the stator core so as to press the first segment coil against the first shaft and so as to press the second segment coil against the second shaft, the first side wall of the first shaft presses the first curved portion radially outward of the stator core and the second side wall of the second shaft presses the second curved portion radially inward of the stator core, and with the first end portion and the second end portion being in contact with each other, the first segment coil and the second segment coil are clamped.

This clamp device can reduce the likelihood that heat generated due to welding will damage the coating film of the segment coils.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a stator produced using a clamp device;

FIG. 2 illustrates a portion of the plurality of segment coils shown in FIG. 1;

FIG. 3 is a perspective view of a clamp device;

FIG. 4 shows one of the shafts included in the clamp device of FIG. 3;

FIG. 5 is a diagram illustrating a positioning step; and

FIG. 6 is a cross-sectional view taken along VI-VI line in FIG. 5.

### DETAILED DESCRIPTION OF EMBODIMENTS

### Stator 10 Manufactured Using a CLAMP Device 100

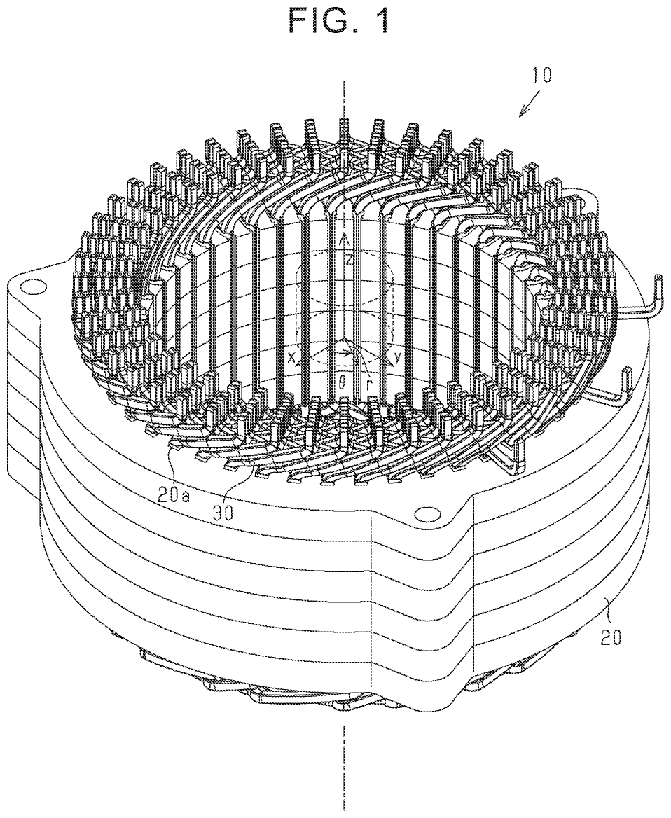

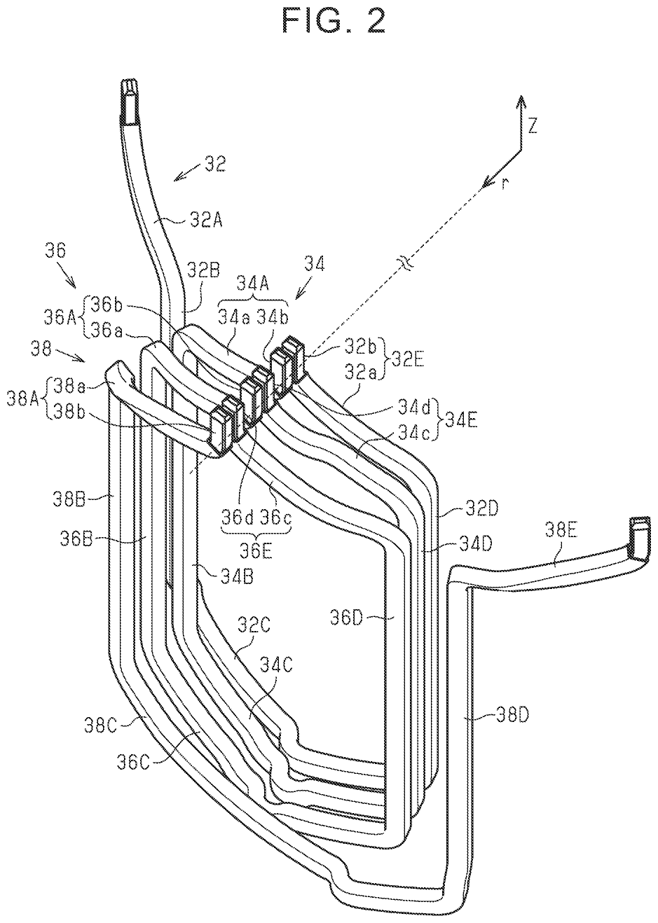

Hereinafter, a clamp device according to an embodiment and a method of manufacturing a stator using the clamp device will be described with reference to the drawings. Referring to FIGS. 1 and 2, a stator 10 manufactured using a clamp device 100 will be described. The center axis of the stator core 20 is indicated by a dashed-dotted line. Hereinafter, a cylindrical coordinate system having a central axis of the stator core 20 as a z-axis is used. Hereinafter, the radial direction r shown in FIG. 1 is referred to as a radial direction of the stator core 20. The angle θ direction is referred to as a circumferential direction of the stator core 20. The axial z direction is referred to as an axial direction of the stator core 20. In addition, two directions along the circumferential direction when the stator core 20 is viewed from above in the negative direction of the axis z are referred to as clockwise when viewed from the axial direction and counterclockwise when viewed from the axial direction, respectively. That is, the counterclockwise direction as viewed from the axial direction is a positive direction in the angle θ direction, and the clockwise direction as viewed from the axial direction is a negative direction in the angle θ direction.

As shown in FIG. 1, the stator 10 includes a cylindrical stator core 20 and a plurality of segment coils 30 accommodated in the stator core 20. The stator core 20 has a plurality of slots 20a arranged at predetermined intervals in the circumferential direction of the stator core 20. Each of the plurality of slots 20a extends radially of the stator core 20. Each of the plurality of segment coils 30 is disposed in two of the plurality of slots 20a.

FIG. 2 illustrates a portion of a plurality of segment coils 30 included in the stator 10 of FIG. 1. FIG. 2 shows only the plurality of segment coils 30 disposed on the stator core 20 without displaying the stator core 20. The plurality of segment coils 30 includes a first segment coil 32, a second segment coil 34, a third segment coil 36, and a fourth segment coil 38. As shown in FIG. 2, the first segment coil 32, the second segment coil 34, the third segment coil 36, and the fourth segment coil 38 are arranged in this order in the radial direction of the stator core 20. The first segment coil 32 is located on the radially innermost side and the fourth segment coil 38 is located on the radially outermost side.

The first segment coil 32 has a first protruding portion 32A protruding upward from the slot 20a and extending clockwise as viewed from the axial direction of the stator core 20. The first segment coil 32 has a first straight portion 32B that is contiguous with the first protruding portion 32A and extends axially through the slot 20a of the stator core 20. The first segment coil 32 has a first connecting portion 32C that is continuous with the first straight portion 32B and protrudes downward from the slot 20a and extends counterclockwise as viewed from the axial direction of the stator core 20. The first segment coil 32 has a first straight portion 32D that is contiguous with the first connecting portion 32C and extends axially through the slot 20a of the stator core 20. The first segment coil 32 has a first protruding portion 32E that is continuous with the first straight portion 32D and protrudes from the slot 20a and extends clockwise as viewed from the axial direction of the stator core 20.

The second segment coil 34 has a second protruding portion 34A protruding upward from the slot 20a and extending counterclockwise as viewed from the axial direction of the stator core 20. The second segment coil 34 has a second straight portion 34B that is contiguous with the second protruding portion 34A and extends axially through the slot 20a of the stator core 20. The second segment coil 34 has a second connecting portion 34C that is continuous with the second straight portion 34B and protrudes downward from the slot 20a and extends counterclockwise as viewed from the axial direction of the stator core 20. The second segment coil 34 has a second straight portion 34D that is contiguous with the second connecting portion 34C and extends axially through the slot 20a of the stator core 20. The second segment coil 34 has a second protruding portion 34E that is contiguous to the second straight portion 34D and protrudes from the slot 20a and extends clockwise as viewed from the axial direction of the stator core 20.

The third segment coil 36 has the same configuration as the second segment coil 34. The third segment coil 36 includes a third protruding portion 36A, a third straight portion 36B, a third connecting portion 36C, a third straight portion 36D, and a third protruding portion 36E.

The fourth segment coil 38 has the same configuration as the second segment coil 34, except that the fourth protruding portion 38E extends counterclockwise as viewed from the axial direction of the stator core 20. The fourth segment coil 38 includes a fourth protruding portion 38A, a fourth straight portion 38B, a fourth connecting portion 38C, a fourth straight portion 38D, and a fourth protruding portion 38E.

As shown in FIGS. 1 and 2, the first segment coil 32 has a first curved portion 32a protruding from the stator core 20 and extending clockwise as viewed from the axial direction of the stator core 20. The first segment coil 32 has a first end portion 32b that is continuous with the first curved portion 32a and extends away from the stator core 20 in the axial direction of the stator core 20. The first curved portion 32a and the first end portion 32b constitute a first protruding portion 32E. The first segment coil 32 is covered with an insulating coating. The first end portion 32b has a first stripped portion that is peeled off from the coating.

The second segment coil 34 has a second curved portion 34a protruding from the stator core 20 and extending counterclockwise as viewed from the axial direction of the stator core 20. The second segment coil 34 has a second end portion 34b that is continuous with the second curved portion 34a and extends away from the stator core 20 in the axial direction of the stator core 20. The second curved portion 34a and the second end portion 34b constitute a second protruding portion 34A. The second segment coil 34 is covered with an insulating coating. The second end portion 34b has a second stripped portion that is peeled off from the coating. The second segment coil 34 has a second curved portion 34c protruding from the stator core 20 and extending clockwise when viewed from the axial direction of the stator core 20, and a second end portion 34d that is continuous to the second curved portion 34c and extends in the axial direction of the stator core 20. The second curved portion 34c and the second end portion 34d constitute a second protruding portion 34E. The second end portion 34d has a second stripped portion that is peeled off from the coating. The third segment coil 36 has a third curved portion 36a and a third end portion 36b that constitute the third protruding portion 36A. The third segment coil 36 has a third curved portion 36c and a third end portion 36d constituting the third protruding portion 36E. The fourth segment coil 38 has a fourth curved portion 38a and a fourth end portion 38b constituting the fourth protruding portion 38A. The first curved portion 32a, the second curved portion 34c, and the third curved portion 36c protrude from the same slot 20a. The first curved portion 32a, the second curved portion 34c, and the third curved portion 36c are arranged in this order in the radial direction of the stator core 20. The second curved portion 34a, the third curved portion 36a, and the fourth curved portion 38a protrude from the same slot 20a. The second curved portion 34a, the third curved portion 36a, and the fourth curved portion 38a are arranged in this order in the radial direction of the stator core 20. The first end portion 32b, the second end portion 34b, 34d, the third end portion 36b, 36d, and the fourth end portion 38b are arranged in the radial direction of the stator core 20, and constitute a group including a plurality of end portions. As shown in FIG. 1, a plurality of groups each including a plurality of end portions are arranged at equal intervals in the circumferential direction of the stator core 20.

### Configuration of the Clamp Device 100

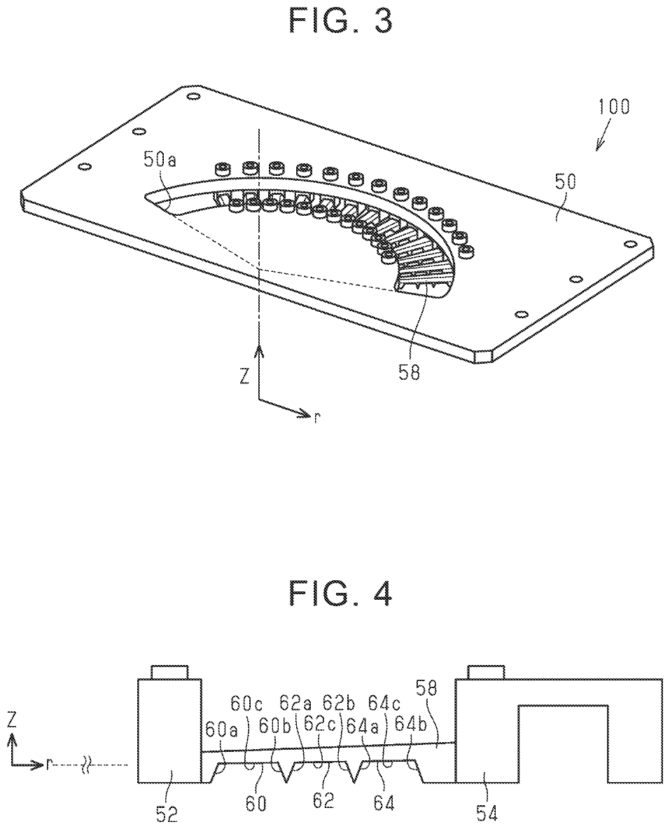

As shown in FIG. 3, the clamp device 100 comprises a support plate 50 having an opening 50a. The opening 50a has a configuration in which an inner arc and an outer arc are connected by two lines substantially perpendicular to the inner arc. The inner arc and the outer arc are concentric and have the same center angle.

The clamp device 100 includes a plurality of shafts 58 having the same shape. Each of the plurality of shafts 58 is fixed to the support plate 50 via the inner attachment portion 52 and the outer attachment portion 54 shown in FIG. 4. The inner attachment portion 52, the shaft 58, and the outer attachment portion 54 are integral with each other, and are arranged in this order in the radial direction of the stator core 20. Each of the plurality of shafts 58 extends radially with respect to the center of the circle of the inner arc of the opening 50a. That is, each of the plurality of shafts 58 is arranged to extend in the radial direction of the stator core 20. The plurality of shafts 58 are arranged at equal intervals along the inner arc of the opening 50a. That is, the plurality of shafts 58 are arranged in the circumferential direction of the stator core 20.

As shown in FIG. 4, the shaft 58 has a plurality of grooves 60, 62, and 64 extending in the circumferential direction of the stator core 20 on the surface on the stator core 20 side. The plurality of grooves 60, 62, 64 have a similar configuration to each other. The plurality of grooves 60, 62, and 64 are arranged in the radial direction of the stator core 20. The groove 60 is defined by a first side wall 60a, a second side wall 60b, and an end wall 60c connecting the first side wall 60a and the second side wall 60b. The first side wall 60a is located radially inward of the stator core 20 from the second side wall 60b. The first side wall 60a and the second side wall 60b are closer to each other toward the end wall 60c. The groove 62 is defined by a first side wall 62a, a second side wall 62b, and an end wall 62c connecting the first side wall 62a and the second side wall 62b. The groove 64 is defined by a first side wall 64a, a second side wall 64b, and an end wall 64c connecting the first side wall 64a and the second side wall 64b.

### Operation of the Clamp Device 100 and a Method of Manufacturing the Stator 10

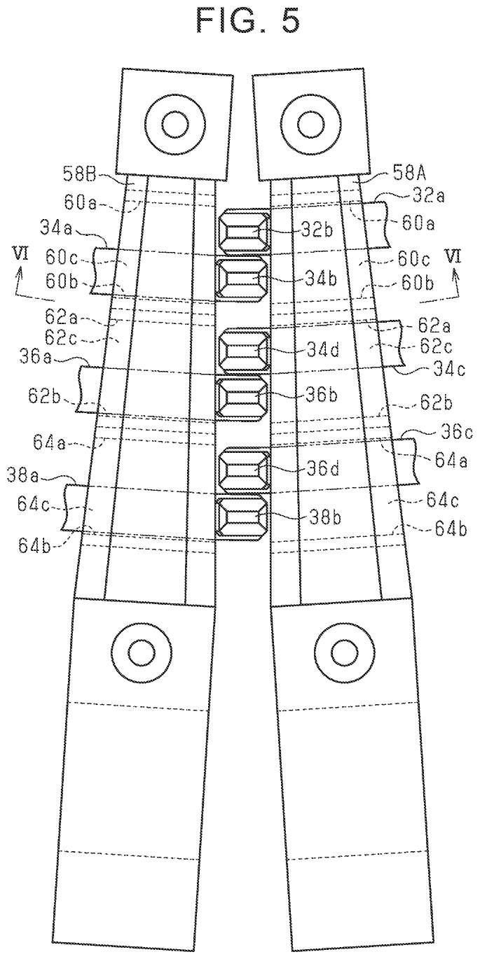

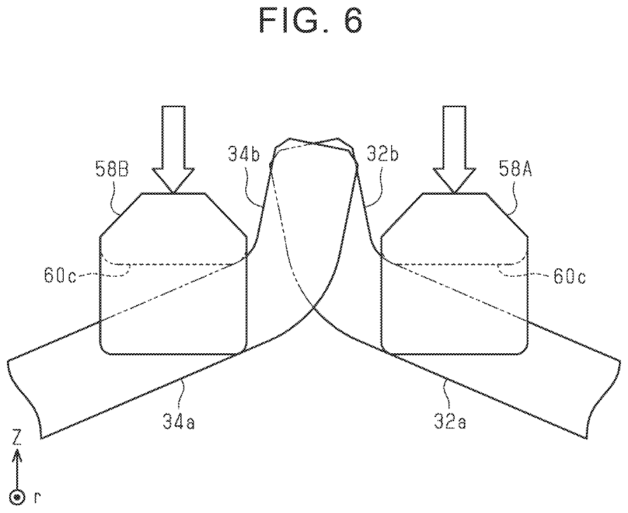

With reference to FIGS. 5 and 6, the operation of the clamp device 100 will be described. Two of the plurality of shafts 58 adjacent to each other can be positioned in a group of ends in a similar manner. Two adjoining ones of the plurality of shafts 58 are referred to as a first shaft 58A and a second shaft 58B, respectively, in the following.

A clamp device 100 is disposed above the stator core 20 shown in FIG. 1. The first shaft 58A and the second shaft 58B are moved downward toward the stator core 20 so that the first end portion 32b, the second end portions 34b, 34d, the third end portions 36b, 36d, and the fourth end portion 38b are sandwiched between the first shaft 58A and the second shaft 58B. Such a downward movement is indicated by a white arrow in FIG. 6. Thus, the first side wall 60a of the first shaft 58A presses the first curved portion 32a radially outward of the stator core 20. The second side wall 60b of the second shaft 58B presses the second curved portion 34a radially inward of the stator core 20. Accordingly, the first end portion 32b and the second end portion 34b can be brought into contact with each other. Here, since the first side wall 60a and the second side wall 60b are closer to each other as they are closer to the end wall 60c, the first end portion 32b and the second end portion 34b gradually approach each other as the clamp device 100 moves downward. Similarly, the first side wall 62a of the first shaft 58A and the second side wall 62b of the second shaft 58B can cooperate to abut the second end portion 34d and the third end portion 36b. Similarly, the first side wall 64a of the first shaft 58A and the second side wall 64b of the second shaft 58B can cooperate to abut the third end portion 36d and the fourth end portion 38b. The clamp device 100 presses the end wall 60c, 62c, 64c of the first shaft 58A against the first curved portion 32a, the second curved portion 34c, and the third curved portion 36c by the downward movement. In addition, the clamp device 100 presses the end wall 60c, 62c, 64c of the second shaft 58B against the second curved portion 34a, the third curved portion 36a, and the fourth curved portion 38a. Thus, the first segment coil 32, the second segment coil 34, the third segment coil 36, and the fourth segment coil 38 are positioned in the axial direction of the stator core 20.

The first shaft 58A and the second shaft 58B are spaced apart from each other in the circumferential direction of the stator core 20 so as to sandwich the first end portion 32b, the second end portion 34b, 34d, the third end portion 36b, 36d, and the fourth end portion 38b. Therefore, the first shaft 58A and the second shaft 58B can restrict the circumferential position of the stator core 20 between the first end portion 32b, the second end portion 34b, 34d, the third end portion 36b, 36d, and the fourth end portion 38b. The positioning process is performed as described above. That is, the plurality of segment coils 30 can be clamped.

Then, the welding process is performed in the clamped posture. In the welding process, the first stripped portion having the coating film peeled off on the first end portion 32b and the second stripped portion having the coating film peeled off on the second end portion 34b are coupled to each other through laser welding with the first end portion 32b and the second end portion 34b facing each other. The second stripped portion of the second end portion 34d and the third stripped portion of the third end portion 36b are coupled in the same manner. The third peeling portion of the third end portion 36d and the fourth peeling portion of the fourth end portion 38b are coupled in the same manner. Upon completion of laser welding at all locations clamped by the clamp device 100, the clamp device 100 performs an unclamping operation.

Next, the clamp device 100 is moved to the next position, and a positioning process and a welding process are similarly performed. These steps are repeated until the welding of all welds of the stator core 20 is completed. This makes it possible to electrically connect all the plurality of segment coils 30 in the stator core 20.

### Effect of this Embodiment

(1) The first segment coil 32 and the second segment coil 34 are clamped with the first shaft 58A contacting the first segment coil 32 and the second shaft 58B contacting the second segment coil 34.

Thus, in a state in which the first segment coil 32 and the second segment coil 34 are clamped, the first stripped portion and the second stripped portion can be laser-welded. The first shaft 58A contacts the first segment coil 32, and the second shaft 58B contacts the second segment coil 34. Therefore, heat generated by the laser welding may be dissipated from the first segment coil 32 and the second segment coil 34 to the first shaft 58A and the second shaft 58B. Thus, the likelihood that heat due to welding will damage the coating of the first segment coil 32 and the coating of the second segment coil 34 is reduced.

(2) In order to form a coil in the stator 10, a plurality of segment coils 30 are arranged concentrically around the rotation axis of the stator 10. Further, a plurality of pairs of two end portions to be laser-welded are arranged so as to be aligned along the radial direction of the stator core 20. The second end portion 34d and the third end portion 36b are located radially outward of the stator core 20 with respect to the second end portion 34b.

According to the clamp device 100 described above, the positions of the second end portion 34d and the third end portion 36b can be restricted at the same time as the positions of the first end portion 32b and the second end portion 34b are restricted.

(3) Two other ends are adjoining the first end portion 32b and the second end portion 34b in the circumferential direction of the stator core 20. At the same time as regulating the position of the first end portion 32b and the second end portion 34b, the position of the other two ends can be regulated. This can be done with the second shaft 58B and a shaft 58 adjoining the second shaft 58B and separate from the first shaft 58A sandwiching the other two ends.

(4) In order to form a coil in the stator 10, the segment coils 30 are arranged such that a plurality of pairs of two end portions to be laser-welded are arranged at equal intervals in the circumferential direction of the stator core 20. According to the present embodiment, a plurality of welding points can be clamped at the same time by the shafts 58 arranged at equal intervals.

### Example of Change

The present embodiment can be modified as follows. The present embodiment and the following modifications can be implemented in combination with each other as long as they are not technically contradictory.

In the above embodiment, the clamp device 100 has a plurality of shafts 58. The number of the plurality of shafts 58 can be changed as appropriate. The number of shafts 58 maybe two or more. In the above-described embodiment, the first end portion 32b, the second end portion 34b, 34d, the third end portion 36b, 36d, and the fourth end portion 38b are arranged in the radial direction of the stator core 20 and constitute a group of six end portions. However, this is merely an example. The number of ends constituting one group can be changed as appropriate. The number of grooves 60, 62, 64 of each of the plurality of shafts 58 can be varied in response to a change in the number of ends that make up a group.

Of the two segment coils 30 to which the ends are welded, the segment coil 30 having the first end portion 32b located radially inward of the stator core 20 is the first segment coil 32. In the above embodiment shown in FIGS. 1 and 2, when viewed from above the stator core 20, the first segment coil 32 has a first curved portion 32a protruding from the stator core 20 and extending clockwise as viewed from the axial direction of the stator core 20. Alternatively, when viewed from above the stator core 20, the first segment coil 32 may have a first curved portion 32a protruding from the stator core 20 and extending counterclockwise as viewed from the axial direction of the stator core 20. In such cases, the second segment coil 34 having the second end portion 34b to be welded to the first end portion 32b has a second curved portion 34a protruding from the stator core 20 and extending clockwise as viewed from the axial direction of the stator core 20. That is, in such a case, the first curved portion 32a extends leftward from the first end portion 32b in FIG. 5, and the second curved portion 34a extends leftward from the second end portion 34b. Even in such a case, the first segment coil 32 and the second segment coil 34 can be clamped by the clamp device 100 of the above-described embodiment. In such cases, the shaft 58 located on the left side of the first end portion 32b and the second end portion 34b in FIG. 5 becomes the first shaft, and the shaft 58 located on the right side of the first end portion 32b and the second end portion 34b becomes the second shaft.

What is claimed is:

1. A clamp device configured to clamp two segment coils disposed in a stator core, the two segment coils being each covered with an insulating coating film, the two segment coils including two curved portions that project from the stator core and respectively extend clockwise and counterclockwise as viewed from an axial direction of the stator core, and two end portions that are respectively continuous with the two curved portions and extend away from the stator core in the axial direction of the stator core, the two end portions including a first end portion of a first segment coil of the two segment coils and a second end portion of a second segment coil of the two segment coils, the first end portion being, of the two end portions, an end portion located radially inward of the stator core, the second end portion being, of the two end portions, an end portion located radially outward of the stator core, the two curved portions including a first curved portion and a second curved portion, the first curved portion being a curved portion of the two curved portions and continuous with the first end portion, the second curved portion being a curved portion of the two curved portions and continuous with the second end portion, the clamp device being used to couple a first stripped portion and a second stripped portion through laser welding with the first end portion and the second end portion facing each other, the first stripped portion being a portion from which the coating film is stripped off at the first end portion, and the second stripped portion being a portion from which the coating film is stripped off at the second end portion,
the clamp device comprising:
a first shaft disposed so as to extend in a radial direction of the stator core; and
a second shaft adjacent to the first shaft in a circumferential direction of the stator core and disposed to extend in the radial direction of the stator core, wherein:
the first shaft and the second shaft are the same in shape;
the first shaft and the second shaft are each provided with a groove extending in the circumferential direction of the stator core on a stator core side surface;
the groove is defined by a first side wall, a second side wall, and an end wall connecting the first side wall and the second side wall, the first side wall being located radially inward of the stator core than the second side wall;
the first side wall and the second side wall are closer to each other as the first side wall and the second side wall are closer to the end wall;
the first shaft and the second shaft are spaced apart from each other in the circumferential direction of the stator core so as to restrict positions of the first end portion and the second end portion in the circumferential direction of the stator core with the first end portion and the second end portion sandwiched between the first shaft and the second shaft, in a state in which the first end portion and the second end portion are sandwiched between the first shaft and the second shaft, by moving the clamp device to be close to the stator core so as to press the first segment coil against the first shaft and so as to press the second segment coil against the second shaft, the first side wall of the first shaft presses the first curved portion radially outward of the stator core and the second side wall of the second shaft presses the second curved portion radially inward of the stator core, and with the first end portion and the second end portion being in contact with each other, the first segment coil and the second segment coil are clamped.

2. The clamp device according to claim 1, wherein:
the groove in each of the first shaft and the second shaft is one of a plurality of grooves in each of the first shaft and the second shaft; and
the first shaft and the second shaft are each provided with the grooves extending in the circumferential direction of the stator core on the stator core side surface, and the grooves are aligned in the radial direction of the stator core.

3. The clamp device according to claim 1, further comprising a third shaft disposed to extend in the radial direction of the stator core, wherein:
the first shaft, the second shaft, and the third shaft are all the same in shape; and
the first shaft, the second shaft, and the third shaft are arranged in order of the first shaft, the second shaft, and the third shaft in the circumferential direction of the stator core.

4. The clamp device according to claim 1, wherein:
the first shaft and the second shaft are two shafts adjacent to each other, of a plurality of shafts that are spaced in the circumferential direction of the stator core, and each of which is disposed so as to extend in the radial direction of the stator core; and
the shafts are all the same in shape.

5. A manufacturing method for manufacturing a stator that includes two segment coils that are each covered with an insulating coating film and disposed in a stator core using a clamp device, the two segment coils including two curved portions that project from the stator core and respectively extend clockwise and counterclockwise as viewed from an axial direction of the stator core, and two end portions that are respectively continuous with the two curved portions and extend away from the stator core in the axial direction of the stator core, the two end portions including a first end portion of a first segment coil of the two segment coils and a second end portion of a second segment coil of the two segment coils, the first end portion being, of the two end portions, an end portion located radially inward of the stator core, the second end portion being, of the two end portions, an end portion located radially outward of the stator core, the two curved portions including a first curved portion and a second curved portion, the first curved portion being a curved portion of the two curved portions and continuous with the first end portion, the second curved portion being a curved portion of the two curved portions and continuous with the second end portion,
the clamp device including
a first shaft disposed so as to extend in a radial direction of the stator core, and
a second shaft adjacent to the first shaft in a circumferential direction of the stator core and disposed to extend in the radial direction of the stator core,
the first shaft and the second shaft being the same in shape,
the first shaft and the second shaft being each provided with a groove extending in the circumferential direction of the stator core on a stator core side surface,
the groove being defined by a first side wall, a second side wall, and an end wall connecting the first side wall and the second side wall, the first side wall being located radially inward of the stator core than the second side wall, and
the first side wall and the second side wall being closer to each other as the first side wall and the second side wall are closer to the end wall,
the manufacturing method comprising:
a positioning step in which the first shaft and the second shaft restrict positions of the first end portion and the second end portion in the circumferential direction of the stator core with the first end portion and the second end portion sandwiched between the first shaft and the second shaft, by moving the clamp device to be close to the stator core so as to press the first segment coil against the first shaft and so as to press the second segment coil against the second shaft, the first side wall of the first shaft presses the first curved portion radially outward of the stator core and the second side wall of the second shaft presses the second curved portion radially inward of the stator core, and with the first end portion and the second end portion being in contact with each other, the first segment coil and the second segment coil are clamped; and
a welding step in which a first stripped portion and a second stripped portion are coupled through laser welding with the first end portion and the second end portion facing each other, the first stripped portion being a portion from which the coating film is stripped off at the first end portion, and the second stripped portion being a portion from which the coating film is stripped off at the second end portion.
